(19) United States
(12) Patent Application Publication
(10) Pub. No.: US 2010/0192009 A1
(43) Pub. Date: Jul. 29, 2010

(54) OPERATION METHOD OF SUPPRESSING CURRENT LEAKAGE IN A MEMORY AND ACCESS METHOD FOR THE SAME

(75) Inventor: Chuan-Jen Chang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANYA TECHNOLOGY CORPORATION, Taoyuan (TW)

(21) Appl. No.: 12/436,095

(22) Filed: May 5, 2009

(30) Foreign Application Priority Data
Jan. 23, 2009 (TW) 98102951

(51) Int. Cl. G06F 11/18

(52) U.S. Cl. 714/8; 714/E11.069

(57) ABSTRACT

A method for suppressing current leakage in a memory includes a column redundancy evaluation which is executed when a memory is powered on so as to find out a failed memory unit of the memory. A current path between the failed memory unit and a pre-charging power source is disconnected according to the column redundancy evaluation result. Thus, bit lines in the failed memory cells are not pre-charged to avoid current leakage occurred between bit lines and word lines in the failed memory cells.

### CROSS-REFERENCE TO RELATED APPLICATION

This application claims the priority benefit of Taiwan application serial no. 98102951, filed Jan. 23, 2009. The entirety of the above-mentioned patent application is hereby incorporated by reference herein and made a part of specification.

### BACKGROUND OF THE INVENTION

1. Field of the Invention

The present invention is directed to an operation method of suppressing current leakage in a memory. More particularly, the present invention is directed to a method to cut off a path between failed memory units and a power source so as to suppress current leakage in a memory which operates under a standby mode.

2. Description of Related Art

In order to increase the yield rate of memory products so as to reduce production costs, current memories have been provided with repairing functions. When some memory cells of a main memory are failed, they are repaired by using redundant memory cells of redundant memories to replace the failed main memory cells.

In the memories provided with the repairing function in the conventional art, the addresses of the main memory cells detected to be failed are recorded, and fuses thereof are cut off by a laser beam. Thus, the failed main memory cells in the main memory are replaced with the redundant memory cells for accessing. That is, data is no longer read from or written into the failed main memory cells, but is read from or written into the redundant memory cells, instead.

However, even the failed main memory cells are repaired, a current leakage on the failed main memory cells still exists under a standby mode because of the locations of bit lines are closely adjacent to word lines under actual layouts of the memories. Therefore, if there is any short circuit occurred between the bit lines and the word lines, the current leakage problem is occurred.

That is, even though the failed main memory cells are replaced with the redundant memory cells to maintain normal operation of the memories, the current leakage problem caused by the failed main memory cells is still existed. Power consumption caused by such current leakage may be minor while the memories operated under a normal operation. However, when the memories are operated under a standby mode, it would be better to reduce the current leakage so as to avoid unnecessary power consumption.

### SUMMARY OF THE INVENTION

The invention provides a method of suppressing current leakage in a memory. In the method, an address corresponding to a failed memory unit is found out and a current path between the found failed memory unit and a pre-charging power source is cut off. Therefore, current leakage in the failed memory unit can be avoided.

An embodiment of the present invention provides a method of suppressing current leakage in a memory. In the method, a column redundancy evaluation is performed to find out a failed memory unit in a memory when the memory is powered on. Then, a current path between the failed memory unit and a pre-charging power source is disconnected according to the column redundancy evaluation result. Therefore, while the memory is being pre-charged after being powered on, the bit lines of the failed memory unit are prevented from being pre-charged so as to avoid current leakage occurred in the failed memory unit.

Besides, another embodiment of the present invention provides a memory accessing method. In the accessing method, a column redundancy evaluation is performed to find out a failed memory unit of a memory when the memory is powered on. The failed memory unit is replaced with a redundant memory unit of the memory for repairing. A current path between the failed memory unit and a pre-charging power source is disconnected according to a column redundancy evaluation result. Therefore, while the memory is being pre-charged after being powered on, the bit line of the failed memory unit is separated from being pre-charged so as to avoid current leakage in the failed memory unit.

In view of the foregoing, the embodiments of the present invention utilize the column redundancy evaluation result to find out the failed memory unit in the memory and disconnect the current path between the failed memory unit and the pre-charging power source. By such manner, the failed memory can be prevent from current leakage problem even though the memory is under a standby mode, and unnecessary power consumption is reduced correspondingly.

In order to make the aforementioned and other objects, features and advantages of the present invention more comprehensible, several embodiments accompanied with figures are described in details below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a circuit diagram of the present invention.

### DESCRIPTION OF EMBODIMENTS

The following description is presented with figures to detail the embodiments of the invention. In the figures, identical or similar reference numerals are used to indicate identical or similar elements.

In an embodiment of the invention, a memory is checked when the memory is powered on so as to confirm a column address associated with a failed memory cells in the memory. Then, a current path between the failed memory cell and a power source is cut off so that a bit line associated with the failed memory cell is no loner pre-charged by the power source. Therefore, current leakage can be prevented when the memory is operated either in a normal operating or in a stand by mode.

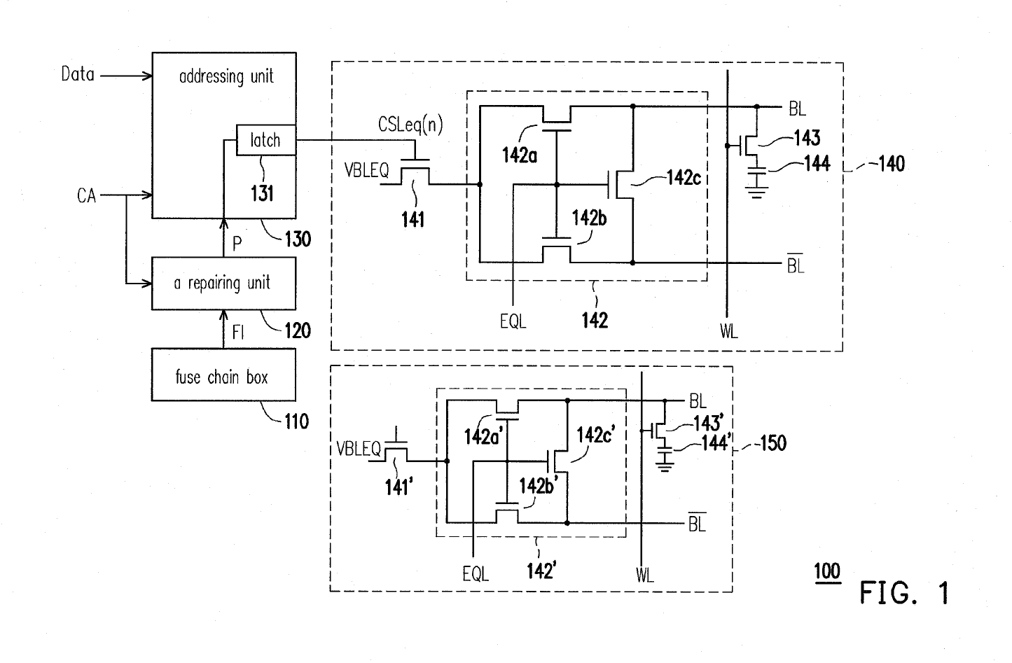

Referring to FIG. 1, FIG. 1 is a circuit schematically showing a memory of an embodiment of the invention which can suppresses current leakage while operating in a normal mod or in a stand by mode. A memory 100 includes a fuse chain box 110, a repairing unit 120, an addressing unit 130, a main memory 140 and a redundant memory 150.

The main memory 140 further includes a plurality of current-limiting units 141, equalizing circuits 142, word line switches 143, memory cells 144, word lines WL, bit lines BL, and complementary bit lines B̅L̅. The redundant memory 150 further includes a plurality of current-limiting units 141′, equalizing circuits 142′, word line switches 143′, memory cells 144′, word lines WL, bit lines BL, and complementary bit lines B̅L̅. The addressing unit 130 includes at least a latch circuit 131. The addressing unit 130 receives data and a corresponding column address CA, as shown. FIG. 1 is a schematic diagram for simple explanation of the embodiment, but it would not be limited thereto, as known by people having ordinary skill in the art.

In the embodiment, the fuse chain box 110 is used to record column addresses respectively associated with corresponding failed memory cells in the main memory 140. Further, the fuse chain box 110 sends a fuse information FI to the repairing unit 120. The repairing unit 120 receives and compares the fuse information FI with the column address CA for accessing, and a comparing signal P is generated accordingly. The fuse information FI includes the column address associated with the failed memory cell in the main memory 140. When the column address CA and the fuse information FI are matched to each other, i.e. the accessing operation to the column address CA is trying to access the failed memory cell, the comparing signal P is at a status of logic low. On the contrary, the comparing signal P is at a status of logic high.

The addressing unit 130 receives the column address CA and the comparing signal P. When the comparing signal P is at the logic-low status, the addressing unit 130 finds out the corresponding latch 131 according to the column address CA. That is, the found latch 131 is corresponding to the failed memory cell. The repairing unit 120 sends the comparing signal P to the found latch 131. Then, the latch 131 outputs the comparing signal P which is at the logic-low status to a column selection line CSLeq(n). When the memory 100 is operated under a normal operation, the addressing unit 130 confirms the column address associated with the failed memory cell in the main memory 140 according to the comparing signal P, and replaces the failed memory cell with the redundant memory cell in the redundant memory for reading or writing a data D from or into the redundant memory cell in the redundant memory unit.

The column selection line CSLeq(n) is electrically connected to a control end of the current-limiting unit 141. When the column selection line CSLeq(n) is at a logic-high status, i.e. the comparing signal P is at the logic-high status, the current-limiting unit 141 is turned on, and then, a reference voltage VBLEQ is coupled to the equalizing circuit 142. The reference voltage VBLEQ is usually a half of a highest voltage level VBLH of the bit line, and the highest voltage level VBLH of the bit line is a voltage level when the bit line is at the logic-high status.

Otherwise, when the column selection line CSLeq(n) is at a logic-low status, i.e. the comparing signal P is at the logic-low status, the current-limiting unit 141 is turned off, and then, the reference voltage VBLEQ will not be coupled to the equalizing circuit 142. The current-limiting unit 141, for example, is a switch such as a transistor. The control end is a gate of the transistor, and a drain and a source of the transistor are coupled to the reference voltage VBLEQ and the equalizing circuit 142 respectively.

The equalizing circuit 142 includes, for example, an equalizing switch 142a, an equalizing switch 142b and an equalizing switch 142c.

The equalizing switch 142a can be, for example, a transistor. The gate of the transistor is electrically controlled by an equalizing signal EQL, a source of the transistor is coupled to the current-limiting unit 141, and a drain of the transistor is coupled to the bit line BL.

The equalizing switch 142b can be, for example, a transistor. A gate of the transistor is controlled by an the equalizing signal EQL, a source of the transistor is coupled to the current-limiting unit 141, and a drain of the transistor is coupled to the complementary bit line B̅L̅.

The equalizing switch 142c can be, for example, a transistor, of which a gate of the transistor is controlled by the equalizing signal EQL, a source of the transistor is coupled to the bit line BL, and a drain of the transistor is coupled to the complementary bit line B̅L̅.

When the equalizing signal EQL is at a logic-high status, the three equalizing switches 142a, 142b, and 142c are all turned on. Meanwhile, there is a short-circuit path between the bit line BL and the complementary bit line B̅L̅. Thus, electric charges on the bit line BL and the complementary bit line B̅L̅ are shared by each other. In addition, the bit line BL and the complementary bit line B̅L̅ are electrically connected to the current-limiting unit 141 so that the bit line BL and the complementary bit line B̅L̅ are pre-charged to the reference voltage VBLEQ only if the current-limiting unit 141 be turned on.

When the e equalizing signal EQL is at a logic-low status, the bit line BL is disconnected to the complementary bit line B̅L̅. Moreover, the bit line BL and the complementary bit line B̅L̅ are not coupled to the current-limiting unit 141.

In the conventional art, if there is any short circuit between the word line WL and the bit line BL or the complementary bit line B̅L̅, there is leak current flowing out from the reference voltage VBLEQ through the bit line BL or the complementary bit line B̅L̅ to the word line WL. However, in the embodiment, if the current-limiting unit 141 is turned on and the equalizing signal EQL is at a logic-high status, the bit line BL and the complementary bit line B̅L̅ are pre-charged to the referenced voltage VBLEQ. If the equalizing signal EQL is at a logic-low status, the bit line BL and the complementary bit line B̅L̅ are not coupled to the current-limiting unit 141. Accordingly, the present embodiment can avoid such problem occurred in the conventional art.

In the embodiment, when the memory is powered on, the redundancy column evaluation is executing, and all the column addresses CA are compared with the fuse information FI for finding out the column address associated with the failed memory cell. If the column addresses CA with the fuse information FI is matched to each other, the comparing signal P is output at a logic-low status. The comparing signal P with the logic-low status is output to the latch 131 corresponding to the failed memory unit. Accordingly, a column selection line CSLeq(n) outputted by the latch 131 is at a logic-low status.

If the equivalent column selection line CSLeq(n) is logic-low and the current-limiting unit 141 is turned off correspondingly, the bit line BL not be pre-charged even though the memory is operated under the standby mode. Therefore, even there is any short path between the bit line and the word line, no current leakage be occurred. By the other way, the logic-low voltage level of the column selection line CSLeq(n) is approximately equal to pre-charging voltage level on the word line WL.

In view of the foregoing, the embodiment compares the fuse information FI and the column address CA to obtain the comparing signal P. The current-limiting unit 141 corresponding to the failed memory cell is turned off according to the comparing signal P. Thus, the failed bit line BL is not pre-charged. That is, there is no current leakage leaked from the word line WL so as to suppress current leakage of the memory under standby mode.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of suppressing current leakage in a memory, comprising:
executing a column redundancy evaluation to find out a failed memory unit of the memory in a powered-on mode; and
disconnecting a current path between the failed memory unit and a pre-charging power source in response to a column redundancy evaluation result so as to avoid current leakage occurred in the failed memory unit.

2. The method of suppressing current leakage in a memory according to claim 1, further comprising:
recording an address associated with the failed memory unit that is previously detected as a fuse information, which is used in the column redundancy evaluation.

3. The method of suppressing current leakage in a memory according to claim 2, further comprising:
comparing an access address with the fuse information to confirm that the corresponding memory unit to be accessed by the access address is one of the failed memory unit and a comparing result is generated accordingly.

4. The method of suppressing current leakage in a memory according to claim 3, further comprising:
sending out a control signal according to the comparing result; and
using the control signal to cut off a current path between the failed memory unit and the pre-charging power source.

5. An accessing method for a memory, comprising:
executing a column redundancy evaluation when a memory is powered on so as to find out a failed memory unit of the memory;
replacing the failed memory unit with the redundant memory unit of the memory; and
disconnecting a current path between the failed memory unit and a pre-charging power source according to a column redundancy evaluation result, thereby bit lines of the failed memory unit are prevented from being pre-charged when the memory is being pre-charged so as to avoid current leakage occurred in the failed memory unit.

6. The accessing method for a memory according to claim 5, further comprising:
recording an address associated with the failed memory unit that is previously detected as a fuse information, which is used in the column redundancy evaluation.

7. The accessing method of suppressing current leakage in a memory according to claim 6, further comprising:
comparing an access address with the fuse information to confirm that the corresponding memory unit to be accessed by the access address is one of the failed memory unit and a comparing result is generated accordingly.

8. The accessing method of suppressing current leakage in a memory according to claim 7, further comprising:
sending out a control signal according to the comparing result; and
using the control signal to cut off a current path between the failed memory unit and the pre-charging power source.
